(19) United States
(12) Patent Application Publication
(10) Pub. No.: US 2014/0143241 A1
(43) Pub. Date: May 22, 2014

(54) INTERNET NEWS PLATFORM AND RELATED SOCIAL NETWORK

(71) Applicants: Daniel Dee Barello, Perry, UT (US); Brian Wayne Barnett, Bluffdale, UT (US)

(72) Inventors: Daniel Dee Barello, Perry, UT (US); Brian Wayne Barnett, Bluffdale, UT (US)

(21) Appl. No.: 14/084,537

(22) Filed: Nov. 19, 2013

Related U.S. Application Data
(60) Provisional application No. 61/727,872, filed on Nov. 19, 2012.

(51) Int. Cl. G06F 17/30

(52) U.S. Cl. CPC G06F 17/30241
USPC 707/724

(57) ABSTRACT

This disclosure is related to a method, related system, and related non-transitory, computer-readable storage medium that implements a social network for aggregating Internet news, and, more specifically, receiving and presenting news content to a user of the social network.

### TECHNICAL FIELD AND RELATED APPLICATION

This disclosure is related to a social network for aggregating Internet news, and, more specifically, receiving and presenting news content to a user of the social network. The present application claims priority to the U.S. Provisional Patent Application No. 61/727,872, filed Nov. 19, 2012, entitled “Internet news platform and related social network,” which is incorporated fully herein by reference.

### SUMMARY

Disclosed herein are embodiments of a news-focused social network platform and of systems, methods, and computer-readable media for providing a news-focused social network service.

Additional aspects and advantages will be apparent from the following detailed description of preferred embodiments, which proceeds with reference to the accompanying drawings.

### BRIEF DESCRIPTION OF THE DRAWINGS

This disclosure includes and references the accompanying drawings, which provide a more particular description of the embodiments discussed herein. The disclosure, however, is not limited to the particular embodiments depicted in the figures. The teachings of the disclosure may be utilized and/or adapted to other embodiments, and/or changes may be made to the disclosed embodiments, without departing from the scope of the disclosure.

FIG. 1 is a diagram of a system for providing a social network service.

FIG. 2 depicts one embodiment of a user interface used to provide a social network service.

FIG. 3 depicts another embodiment of a user interface used to provide a social network service.

FIG. 4 depicts another embodiment of a user interface used to provide a social network service.

FIG. 5 depicts another embodiment of a user interface used to provide a social network service.

### DETAILED DESCRIPTION OF PREFERRED EMBODIMENTS

The social network service disclosed herein may be provided by a social network platform comprising one or more servers. At least one server is configured to receive content from various sources for promulgation to one or more users. In some embodiments, the server stores received content. In some embodiments, the server only stores a hyperlink, or similar reference, pointing to a location on another, third-party server where the content is stored. In some embodiments, a cache version of popular content stored on third-party servers is temporarily stored on the social network servers to improve performance.

The social network disclosed herein may be comprised of users subscribing to (i.e., following) the actions of other users. These subscriptions may be one-way subscriptions where no approval is required of the subscribee. For example, user A in Chicago, USA is subscribed to user B in Baghdad, Iraq and user C in Rome, Italy. When user A accesses the social network service, the user will see updates and content from their social network, that is from users B and C. User subscriptions allow new content to propagate throughout the social network and throughout the world. User subscriptions allow users to immediately inform their subscribers of newly posted content

The social network service disclosed herein may be configured to aggregate syndicated news content from various sources. In some embodiments, the syndicated news content is received from traditional sources, such as a news agency, news bureau, news service, wire service, newswire, newspaper, news organization, television station, radio station, or the like. In some embodiments, the syndicated news content is received from new media sources, such as a website, web log (i.e., “blog”), social network service (e.g., Facebook, Twitter, Google+, MySpace, etc.), social media service (e.g., YouTube, Instagram, etc.), internet forum, automated news feed, podcast, or the like. In some embodiments, the content includes indicia of its source (e.g., AP, CNN, YouTube, etc.),

The social network service may be configured to receive news content generated by a user. This user-generated content may be uploaded to one or more servers. User-generated content is stored on the server(s). In some embodiments, the content includes indicia of its source. In some embodiments, the news content comprises elements received by a syndicated source and elements generated by the user. As an example, a user may create a rebuttal to syndicated news and include the syndicated content with the user-generated rebuttal. As another example, a user may create a poll asking for responses to a syndicated news video.

An individual piece of content stored on the database may be referred to as a “node.” When nodes are stored on a social network server, a record of the content is made in a database. Such a node may include one or more indicia of the node's attributes. Indicia may be in the form of metadata tags, such as hash tags, location-tags (i.e., “geotags”), date, time, viewer names, recipient names, or the like. A hash tag is a word or phrase generally used to indicate that content falls under a particular topic. Hash tags are often prepended with a hash symbol “#”; however, another symbol may also be used. A geotag is a string of characters that refers to a particular geographic region or location. Geotags may be geographic coordinates, location names, or region names and may refer to the location of the content described in the node, the current location of the user, or another location relevant to the node's content. In some embodiments, a geotag may be prepended with a symbol such as a “˜”, “̂”, or similar symbol. Other attributes associated with the nodes may include one or more of the following: topic, geographic origin, author, geographic location described by the content (e.g., “Washington, D.C.” if the content is a news article discussing new laws passed by the U S. Congress), keywords associated with content (e.g., “Wall Street” if the content is a news article discussing financial markets), a source of the content, and any other suitable characteristic. Attributes may be user defined or may be automatically defined by the social network platform.

As used herein, news content refers to any content, both user-generated and syndicated, related to news items. Examples of news content include, but are not limited to, articles, documents, comments, maps, images, videos, discussion boards, collections of content, or the like.

In some embodiments, news content further comprises requests for information (RFI). An RFI enables a user of the social network service to seek information on a particular topic from other users in the social network community. An RFI can be associated with a metadata tag that indicates the RFI is associated with a particular topic, location, or individual. An RFI can be tagged with a location to prompt responses from users in that location. For example, user A from Melbourne, Australia may be seeking information on Australian influence in the Saudi Arabian oil industry. User A, if unable to find the information desired, may post an RFI and tag Saudi Arabia. User B, who lives in Saudi Arabia, and user C, an American oil tycoon, would both see the RFI since they are searching for content tagged in Saudi Arabia. They could respond to A's RFI. The result is that user A receives the desired information, users B and C receive satisfaction from their efforts, and the entire social network community is enlightened. In some embodiments the RFI may be tagged with a user in lieu of, or in addition to, a geotag. In some embodiments, the RFI may be restricted to users of certain locations, to users belonging to particular industries or having particular expertise, or to specific users. A user's expertise may be established via credential, via recommendation, or via activity (e.g., posting content related to a particular topic). For a restricted RFI, only matching users would be permitted to respond to the RFI.

In some embodiments, news content may comprise collaborative content, where two or more users work together to create content. Collaborating users do not have to be linked via a social network, although they may be. In some embodiments, collaborating users can be added by invite-only or they can be allowed to join freely. In some embodiments, an originating user initiates the collaborative content and serves as an editor. Alternatively, the originating user may appoint another user to be an editor. The editor would approve contributions to the collaborative content. In some embodiments a user will serve as a moderator for an open enrollment type collaborative project. Collaborative content may be published under a group identity, under a list of contributing authors, or under a single author. Collaborating users may be given the option to add their own unique official opinion to the content. An official opinion may be a linked comment, a section of the collaborative content, or an appendix to the collaborative content. In some embodiments, collaborative content means a user inviting another user to comment on content.

In some embodiments, the news content may be factual documents instead of opinion articles. These factual documents may comprise scientific reports, meeting notes, legislative bills, legal opinions, voting records, or the like. The social network platform may be configured to facilitate crowd-sourced dissection of factual documents so that objective facts, where they exists can be discerned and distinguished from subjective opinions. The social network platform may be configured to visually distinguish identified facts from opinions.

Sources, or references, may be listed for any content at any level. For example, a source may be listed for an entire article or for a particular paragraph, sentence, or word of the article. Sources may be listed by an authoring user or may be listed by another user. When another user lists a source or reference for user-generated content, approval may be required of the authoring user. The social network platform may be configured to visually display sources and references attached to any content at any level. A source or reference may be a hyperlink internal or external to the social network service, books, periodicals, or the like. When collaborating users provide a section for a collaborative content, sources may be shown for each section of the collaborative content.

The social network service disclosed herein may be configured to present news content to a user via a human-machine interface (HMI). An HMI is any suitable combination of input and output devices configured to receive input from a user and to display, or otherwise present, content to a user. Examples of input devices include keyboards, keypads, mice, pointing devices, touch-screens, voice recognition interfaces, and the like. Examples of output devices include monitors, displays, projectors, speakers, and the like.

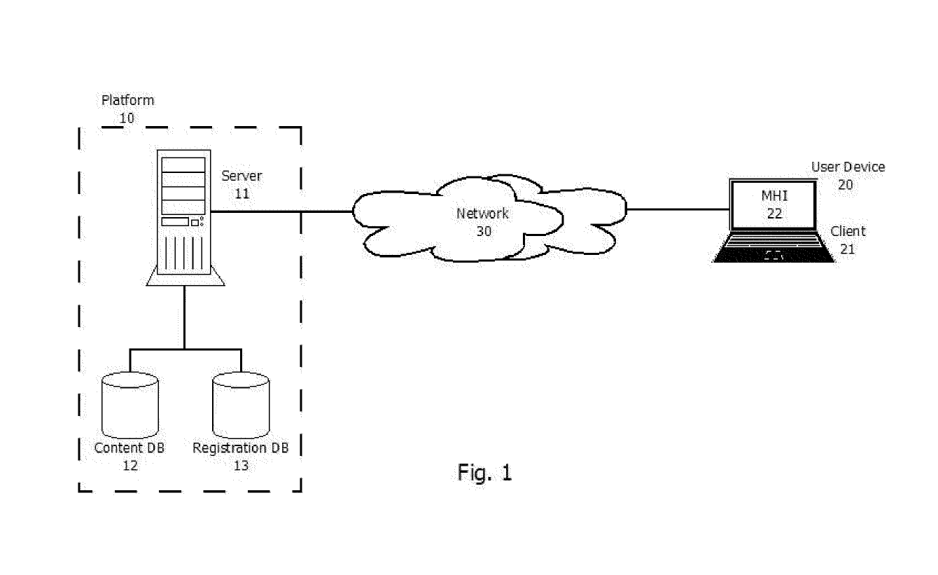

FIG. 1 is a diagram depicting a system for providing a social network service. The system may comprise a social media platform 10 and one or more user devices 20. Although, for the sake of simplicity, only one user device is depicted in FIG. 1, the system may comprise a plurality of user devices. The social media platform may comprise one or more servers 11 and may be configured to interact with a user device via one or more communication interfaces 30. The platform may further comprise one or more databases 12, 13 communicatively coupled to the one or more servers 11. Although the database(s) 12, 13 are depicted in FIG. 1 as being separate from the server(s) 11, in some embodiments, the database(s) may be integrated with the server(s) 11. Each of the one or more server(s) 11 is configured to communicate with s plurality of user devices 20. A user device 20 is any computing device capable of communicating with the social network server(s) 11 to receive the social network service. In some embodiments, the user device 20 comprises a mobile device such as a mobile phone, smartphone, tablet computer, or the like, A user device 20 may comprise a client 21 configured to communicate with the social network platform and a human-machine interface 22 for receiving user input and presenting news content. A client 21 is an application, process, or system configured to access the social network service via the social network platform 10. In some embodiments, the client 21 may be a program or application dedicated solely to accessing the social network service. In some embodiments, the client 21 is a web browser configured to access the social network service.

The social network platform 10 may comprise at least one database 12, 13 configured to store news content and attributes of the content. The database(s) may be stored on a server. As depicted in FIG. 1, the one or more databases may comprise a content database 12 and a registration database 13. In some embodiments, the content database 12 comprises indicia of attributes of content as well as the content itself. In some embodiments, the indicia of attributes are stored in a separate database from the content. The attributes are searchable and allow a user to discover news content. The registration database 13 comprises user profiles created when a user registers for the social network service. In some embodiments, a social network server 11 may be configured to receive a search query from a client 21, the query comprising attributes of news content desired by a user, The server 11 may be further configured to query a content database 12 for content matching the received attributes and to return the results to the client 21. In some embodiments, the server 11 sends matching content to the client 21 instead of, or in addition to, the query results. In some embodiments, the client 21 requests particular content from the social network platform 10 responsive to receiving the query results from the server 11.

The system for providing a social network service disclosed herein is may comprise one or more clients 21 residing on user devices 20. The clients 21 may be configured to prompt a user for login credentials upon startup and to send the login credential to a registration server 13 for verification. A user requesting access to the social network service will be prompted to provide login credentials for an existing account or to create a new account. In some embodiments, a user can skip the login process and access the social network service as a non-registered user (e.g., as a visitor or guest). In some embodiments, a non-registered user has restricted access to the social network service. For example, a non-registered user may be able to view content but may be unable to submit or edit content. In another example, a non- registered user may be able to view some content such as articles, polls, comments, votes, and the like, but may be unable to view profiles of registered users.

A user creating a new account may be prompted to select login credentials for the new account. Login credentials may comprise a username and password. In some embodiments the username is a unique string of characters identifying the account. In some embodiments, the username is an email address of the user. After selecting login credentials, the user may be prompted to create a user profile associated with the new account. The user profile may comprise the name of the user, an email address, a birthday, a current location of the user, and a language spoken by the user. The user profile may further comprise information regarding an occupation and an education of the user. The user profile may further comprise one or more aliases for the user. An alias can be an alternative persona under which a user accesses the social network service. The alias can further comprise additional information about the alternative persona such that the alias mimics a second profile (e.g., having birthday, language, occupation, and education information for the alternative persona).

Aliases allow users to operate in anonymity with respect to other users in the social network. An alias gives a user privacy, as the actions of the alias are not connected to the actions of the user's real persona. While the other users in the social network cannot see the association between the user's real persona and the alias, the system recognizes the association and treats the real persona and the alias as one user. That is to say that the system will treat them as one user, only counting the user once in polls, liking/disliking articles, etc. Adding an alias enables users to quickly toggle back and forth between using a real name and an alias to insert content into the website, thus providing users privacy when needed.

Aliases may be shared among a group of users for publishing group content. Group aliases may be managed by a primary user. In some embodiments, approval is required from a primary user before another user can associate a group alias with his or her profile. In some embodiments a primary user can pre-approve certain users to use the group alias. In some embodiments, an organization shares an alias among all registered users so that each user can publish content on the organization's behalf.

A user creating a new account may be presented with the option of signing in using an existing account with another, third-party social network. For example, the user may be prompted to sign in using an account with Facebook, Twitter, or the like. A new account will then be created using data gathered from the third-party social network. In some embodiments, the user prompted to select a separate password. In some embodiments, the user is able to select a new username. The user may be further prompted to add an alias to the new account or to provide user profile details not obtained from the third-party social network.

A user expands his or her social network by linking to other users. In some embodiments a one-way subscription model is used wherein a user can “subscribe” or “follow” another user without needing approval from (or knowledge of the subscription by) the another user. In this model, the subscription is one-way such that the subscriber sees activity by the subscribee, but the subscribee does not necessarily see activity by the subscriber. Put another way, the subscriber's social network will comprise the subscribee, but the subscribee's social network does not necessarily comprise the subscriber. Nothing in this model prevents the original subscribee from then subscribing to the original subscriber; however, in this model such a two-way subscription is not automatically formed, but is formed only when each user subscribes to the other. In some embodiments a two-way subscription model is used wherein a petitioning user initiates a two-way subscription with a petitioned user. Upon approval by the petitioned user, a two-way subscription is formed wherein the petitioned user is a part of the petitioning user's social network and vice versa. Should the petitioned user decline the subscription, neither user will be part of the other's social network. In some embodiments, a hybrid subscription model is used wherein some users are connected via a one-way subscription and other users are connected via a two-way subscription. In the hybrid model, a user may be able to designate that certain content is accessible by two-way subscribers (i.e., “friends”), by one-way subscribers (i.e., “followers”), or by either type of subscriber (i.e., both friends and followers).

In some embodiments, a user is able categorize their subscriptions (both one way and two-way). A subscription may be placed into any number of categories or no category at all. For example, consider user A who is subscribed to users B, C, and D. User A may place user B into a “gardening” category, may place users B and C into a “politics” category, and may leave D uncategorized.

In some embodiments, users may elect to receive notification of activity of any subscription or subscription category. A notification may comprise a text message, an email, an instant message, or an online alert (e.g., a pop-up window or on-screen notice). In some embodiments, notifications may be received via other social networks, e.g., Twitter. A user's profile may comprise telephone numbers, email addresses, IM usernames, or other means of providing instant notifications. In some embodiments, a user can indicate a preference to receive certain notifications via one form (e.g., via email) and other notifications via another form (e.g., text message).

In some embodiments, a user is able to prevent activity by the user or content generated by the user from being accessed by other users in certain locations. For example, a user may restrict a poll to users in (or not in) a particular geographical area. As another example, a user may generate an article and limit distribution of the article to a particular geographical area. This is particularly useful where an article contains material subject to intellectual property restrictions in one area but not in another. In some embodiments, a user may restrict access to the user's activity or generated content to a particular field (i.e., industries) or category (i.e., “gardening”). The user may tailor content for a specific audience and release the content to only that audience

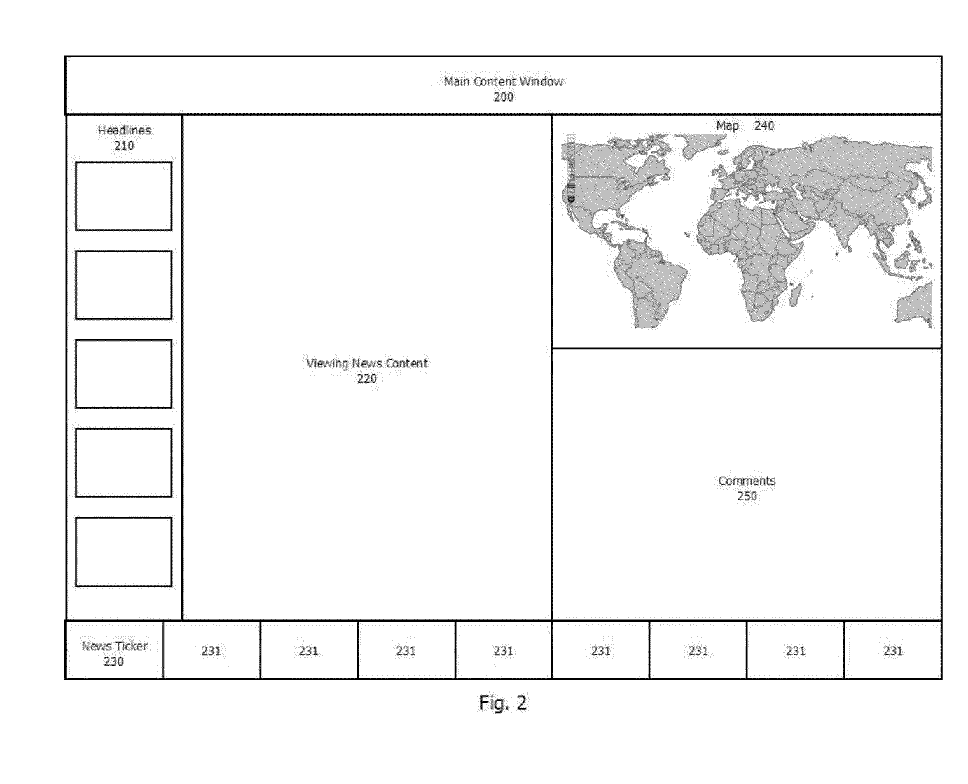

According to one embodiment, after a user logs into the social network, the client presents user interface comprising a main content window to the user. FIG. 2 depicts one embodiment of a main content window 200. The main content window 200 comprises headlines 210, viewing news content 220, a scrolling news ticker 230, a map 240, and comments 250 relating to the viewing news content. The viewing news content may comprise an article, a document, a multimedia object, a poll, or a discussion. In some embodiments, the user is initially presented with the day's headlines 210 in lieu of news content 220. The headlines 210 may be based on trending content. In some embodiments the headlines are based on metadata tags or other criteria defined by user. A user can select a headline 210 of interest and then view the news content 220 associated with the headline. In some embodiments the user is able to filter or sort headlines according to suitable criteria. As an example, a user can filter headlines so that only headlines from a certain time frame are displayed. As another example, a user can sort headlines by distance from a specified location. As yet another example, a user can sort headlines alphabetically by title or by name of author.

In some embodiments, the layout and organization of the main content window 200 is determined by the system. In some embodiments, the layout and organization of the main content window 200 can be customized by the user.

In some embodiments, the news ticker 230 is populated with links to popular or trending news content. In some embodiments, the news ticker 230 is populated with news content that is popular or trending in a particular geographical region. In some embodiments, the news ticker 230 comprises a plurality of news ticker items 231 and is populated with news content of a particular subject or topic that is popular or trending. In some embodiments, the news ticker 230 is populated with news content that is popular or trending among other users (or aliases) that the user is following. In some embodiments, the news ticker 230 may comprise notification of activity by a subscription. In some embodiments the user is able to filter or sort news ticker items 231 according to suitable criteria. As an example, a user can filter news ticker items 231 so that only items from a certain time frame are displayed. As another example, a user can sort news ticker items 231 by distance from a specified location. As yet another example, a user can sort news ticker items 231 alphabetically by title or by author name. From the main content window 200, a user can select news content of interest in the news ticker 230 and then view the selected content 220. In some embodiments, comments 250 relating to news content being viewed 220 are displayed in the main content window 200. While news ticker 230 is depicted as being a panel or area within main content window 200, in some embodiments news ticker 230 may be a separate window or a pop-up window.

Trending content is content that is becoming popular among users of the social network service. In one embodiment, a distinction is made between content that is “trending” and content that is “popular”. Where the popularity of a particular news content may be determined by the number of views or “hits” over a given time period, content can be determined to be trending based on its change in popularity. In some embodiments, the “trend” of content is based on its relative change in popularity (i.e., compared to other content). In some embodiments, the “trend” of content is based on its rate of change in views per time period. In some embodiments, content must have a minimum number of hits before it is determined to be trending. In some embodiments, content must meet a certain threshold of popularity before it is determined to be trending.

Referring to FIGS. 1 and 2, in some embodiments, the client 21 may be configured to allow the user to indicate, via the HMI 22, content to be saved for later. In some embodiments, a local copy of the content is downloaded to the user device 20. In some embodiments, a link or pointer to the content is downloaded to the user device 20. In some embodiments, information is stored on a social network server 11 indicating that the user has saved the content for later. In some embodiments, a link or pointer to the content is stored with the user's profile in a registration database 13. Links to saved content may be displayed on the main content window 200 or another suitable window, frame, or page. Saved content facilitates research by the user and allows favorite content to be quickly accessed

The client 21 may be further configured to allow a user to indicate favorite locations or personas. These favorites may be stored with the user's profile (e.g., in registration database 13) and may allow a user to quickly find content published from or about a favorite location, or published by a favorite persona. The favorite persona may be an individual user, a group, or an alias.

A user viewing news content 220 may be able to leave comments 250 for the news content. In some embodiments, the user can indicate (i.e., “target”) a particular section or portion of the viewed content 220 (e.g., a paragraph of an article or scene of a video file) with which the comment 250 is associated. This differs from conventional comments which are associated only with the content as a whole. Targeted comments facilitate better discussion and allowing a commenting user to direct their comments to specific ideas embodied in the news content.

A user viewing news content 220 may be able to express sentiment towards the content. In some embodiments, the viewing user can “like” or “dislike” viewed content 220. In some embodiments, the viewing user can assign a ranking to viewed content 220. In some embodiments, the viewing can assign a rating (e.g., 4 stars) to viewed content 220. In some embodiments, the sentiment is applied to the viewed content 220 as a whole. In some embodiments, the sentiment is applied to a particular section or portion of the viewed content 220. For example, a user can “like” certain paragraphs of an article while remaining neutral towards (or indicating dislike for) other paragraphs.

In some embodiments, when a user first logs in to the social network, or when no content is currently selected, viewed content panel 220 may show recent activity by the user or the user's subscriptions, notifications for the user, suggested links, personas, or groups, or other media related to recently viewed content. In some embodiments, comment panel 250 may show recent activity by the user or the user's subscriptions, notifications for the user, suggested links, personas, or groups, or other media related to recently viewed content where no content is currently selected.

A user of the social network service may be able to participate in polls and discussions started by other users in the social network. In some embodiments, participation may be restricted to certain location, certain persona, or certain time frames. In some embodiments, participation is restricted to the social network of the creator. In some embodiments, participation is open to any user of the social network service. In some embodiments, polls and discussions may be created by users of the social network service. In some embodiments, collaborative polls and discussions may be created by a group of users of the social network service. In some embodiments, polls and discussion may be created by administrators of the social network service.

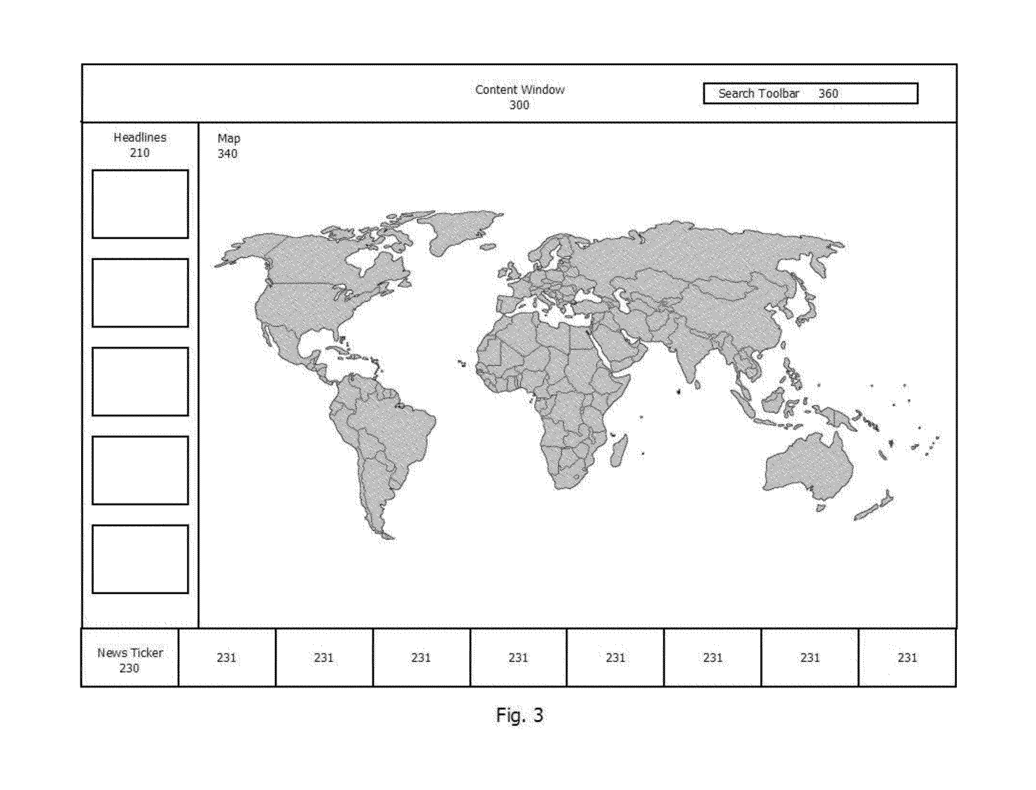

FIG. 3 shows an embodiment of a user interface comprising content window 300. As depicted, the content window 300 may comprise headlines 210 (as discussed with reference to FIG. 2), a news ticker 230 and news ticker items 231 (as discussed with reference to FIG. 2), and map 340. Content window 300 differs from main content window 200 in that an enlarged map 340 is presented in lieu of viewing news content 220, map 240, and comments 250. A user of the social network service may be able to view social network activity on a map (e.g., map 340). In some embodiments, the map 340 is presented to the user as part of the content window 300. In some embodiments, the map is viewed by itself in a separate content window.

In some embodiments, the map 340 may show user activity or user sentiment towards particular news content. When showing user sentiment, the map 340 may comprise indicia of likes/dislikes, votes, poll results, or the like, per geographic region. As an example, the map 340 may highlight cities where a significant number of users “like” an associated news article. When showing user activity, the map 340 may comprise indicia of user-generated content, comments, views (i.e., hits), or the like per geographic region. For example, the map 340 may highlight cities where a significant number of users generate news content (e.g., articles or videos) related to a particular subject. As another example, the map 340 may show the number of hits an article has received per country. As another example, the map 340 may show regions where a significant amount of comments for a news article are made. The map 340 may show what news content is trending in different regions. For example, the map 340 can show that a video related to a political convention is trending in many cities while an article related to the same convention is only trending in a few cities.

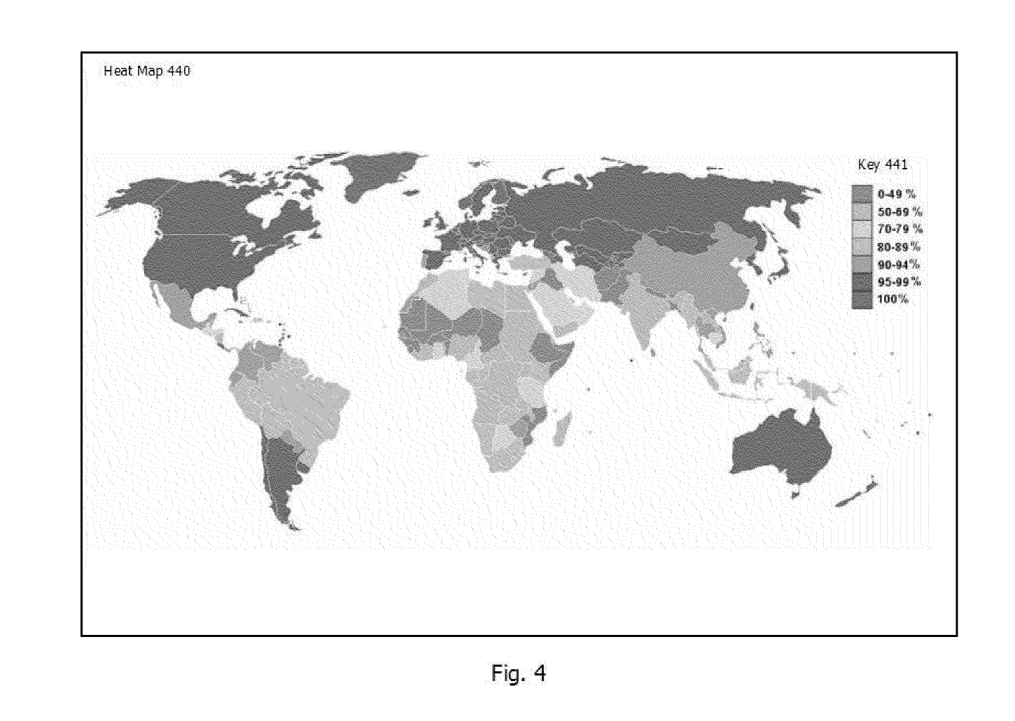

As depicted in the embodiment of FIG. 4, the map 240 or the map 340 may be a heat map 440 which uses colors, hues, or tints to represent data values. The heat map 440 may comprise a key 441 for interpreting the colors on the heat map 440. The heat map 440 may be used to show global activity where different colors to show different levels of activity. The heat map 440 may be used to show global sentiment where different colors are used to show different levels of favorable or unfavorable sentiment towards an article or other news content. The heat map 440 may be used to show the results of a poll. The heat map 440 may be used to show the popularity of particular news content with different colors used to show different levels of popularity. In some embodiments, the heat map 440 shows sentiment or activity related to a particular portion of an article, document, or other content. In some embodiments, heat map 440 shows sentiment or activity related to a particular user, group, or alias. As an example, the heat map 440 may show which paragraphs of a news article are popular and which are controversial, As another example, the heat map 440 may show which paragraphs of a news article paragraphs receive the most comments. As another example, the heat map 440 may show where content receives the most views. In some embodiments, another mechanism for indicating activity or sentiment could be used instead of a heat map 440.

As contemplated, heat maps may be used to display anything that has statistics. Heat maps may be used to show a user's activity, to show a subscription's activity, to show a user's followers, or other profile-related statistics.

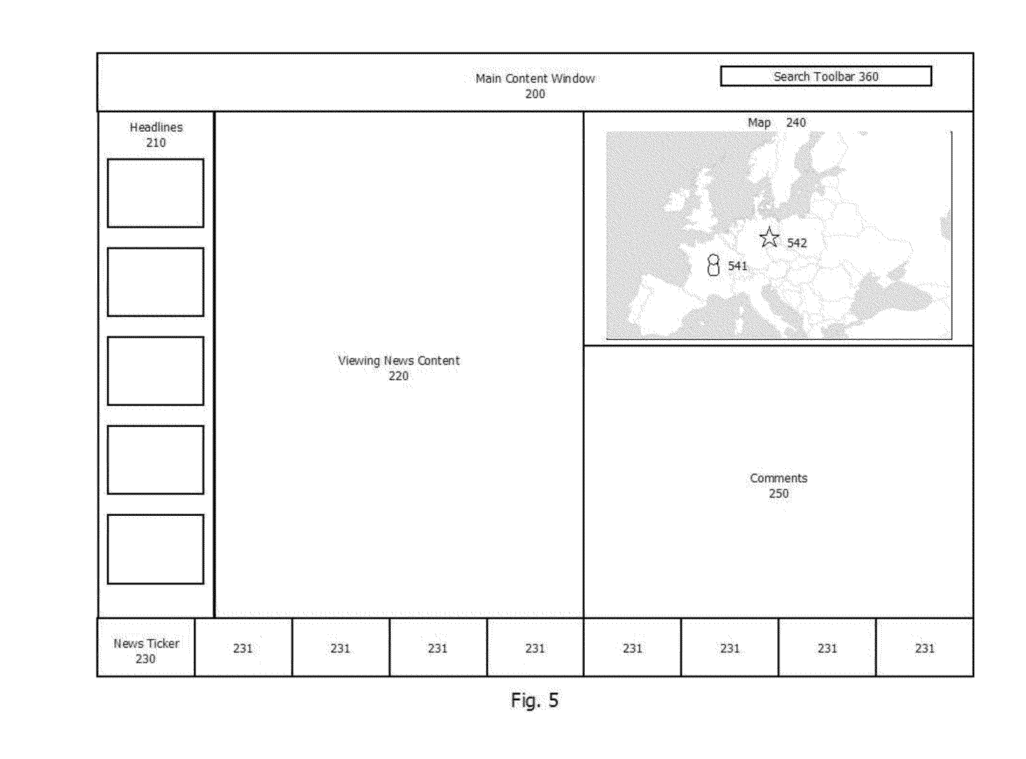

As depicted in the embodiment of FIG. 5, the map 240 may comprise location icons 541 and 542. In some embodiments, a location icon 541 is displayed to indicate the location of an author or generating user. In some embodiments, a location icon 542 is displayed on the map 240 to indicate a location relevant to the news content (e.g., the site of a published interview or the setting of a news article).

Referring to FIGS. 3 and 5, in some embodiments, the main content window 200 and/or the content window 300 further comprises a search toolbar 360 whereby a user can search for content, locations, users (or their aliases), or the like. The search toolbar 360 works by receiving one or more search terms received from the user via the HMI (e.g., HMI 22). The search terms may be metadata tags (e.g., hash tags, geotags, etc.), keywords, or any other suitable inputs. The search toolbar 360 may be available to both registered users and unregistered users. A search functionality causes the client (e.g., client 21) to send a search query to a server in the social network platform (e.g., sever 11), the search query comprising the inputted search terms. The client 21 receives from the server 11 a search response comprising results of the search. In some embodiments the search results comprise content having attributes matching the search terms (e.g., having matching metadata tags or comprising matching keywords). In some embodiments the search results comprise a list of pointers to content having attributes matching the search terms. The list of pointers may include a brief description and/or thumbnail image of the matching content.

In some embodiments the user is able to filter or sort search results according to metadata tags or other suitable criteria As an example, a user can filter results so that only results from a certain time frame are displayed. As another example, a user can sort results by distance from a specified location. As yet another example, a user can sort results alphabetically by title or by author name.

A variety of different metadata tags may be used in relation to news content. In some embodiments, user-generated hash tags are associated with news content and used to label or “tag” the content with a particular theme or topic. In some embodiments, user-generated location tags are associated with news content and used to identify a location relevant to the news content (e.g., the site of a published interview or the setting of a news article). In some embodiments, user-generated person tags are associated with news content and used to identify people mentioned in the news content. In some embodiments, hash tags are used to indicate the source of the news content. In some embodiments, the system suggests relevant metadata tags to the user based on a computer analysis of the content. In some embodiments, the system automatically associates metadata tags with the content based on a computer analysis of the content. In some embodiments, the system automatically associates a location tag with user-generated content based on the location of the generating user. In some embodiments, the system automatically associates a person tag with user-generated content based on the identity of the generating user.

The system for providing a social network service may comprise functionality for converting coordinate-style geotags into place-name geotags and vice versa. As an example, the functionality may convert the location tag of “Washington, D.C.” with the appropriate GPS coordinates for the city. As another example, the functionality may convert a location tag comprising the GPS coordinates for San Francisco, Calif. into a location tag comprising the name “San Francisco, Calif..” In some embodiments, the system automatically analyses location tags and converts from coordinates to place names (or vice versa) automatically.

A user of the social network service may be able to define a set of tags (a “tag set”) relevant to that user. The tag set may be used to define the news feed for the user, that is the a server will query the social network service's database of content for content matching the user's defined tag set and will send the hits to the user's client to populate the newsfeed. In some embodiments, the tag set may be user defined where the user indicates to the social network service which tags to add to the tag set. In some embodiments, the system automatically associates tags with a user according to news content the users “likes” or rates highly. In some embodiments, the system may analyze news content the user has viewed to determine common tags and suggest the user add the common tags to his or her tag set. In some embodiments, the system may analyze a user's search queries to suggest tags to add to the user's tag set.

A user of the social network service may be able to create a collection of content (a virtual “folder” or “binder”). A collection may comprise of a title, description, summary, and the like. A collection may consist of uploaded content and/or links to other content either on the social network or to an external site. A collection may be private or published, single-authored or collaborative, and open for edits or closed. Comment and/or narrative may be added to the collection as a whole or on individual parts by the author(s) and the entire community at the author(s) discretion. Distinction may be made between content added by different users. The server may log read status (e.g., “read” or “unread”) as a service for each user.

In some embodiments, a user may be allowed to suggest content to another user, effectively adding the content to a “reading list” collection. In some embodiments, the user is first taken to the reading list after logging in. In some embodiments, the reading list is shown at viewing content panel 220 or at comments panel 250 of main content window 200 if no content has been selected. In some embodiments, collection content added by a user is visually distinguished from content suggested by another.

One service that may be provided by the social network platform 10 is to translate news content into another language The social network platform 10 may be configured to allow users speaking different languages to view parallel versions of the same news content. In some embodiments, the translation service is provided by human translators. The human translators may comprise professional translators, amateur translators, or users of the social network service. In one embodiment, a user speaking a second language may provide a user-generated translation of news content. In one embodiment, a content-generating user (e.g., an author) that speaks a second language may provide a translation of the user's own generated content. In some embodiments, both authors and other users are able to generate translations for content and the social network platform presents an author-generated translation differently than a user-generated translation.

In some embodiments, the social network platform may translate news content using machine translation. Machine translation refers to the use of computer software and/or hardware to translate between natural languages. In some embodiments, translations are generated using statistical models derived from the analysis of parallel text which are assumed to be perfect translations. In some embodiments, the machine translation service is configured to have an expanding parallel text database wherein user-generated parallel text are used to supplement the existing parallel text database. In some embodiments, the machine translation service allows a bilingual user to rate the accuracy of the translation and suggest corrections which may then be added to the parallel text database. In some embodiments, the machine translation service tracks changes made by a user and the geographic location of the user so as to capture regional differences in language and further improve the machine translation service. In some embodiments, the machine translation service may prompt the user to provide reasons for making changes to the translated content and may later use the provided reasoning to improve the translation model or algorithm.

In some embodiments, the machine translation service allows for crowd-sourced review of the machine translated content so that a plurality of users can provide input as to the accuracy of the translation. In some embodiments, the social network platform permits only a single, dynamic translation (parallel text) per language for a particular news content. The machine translation service may track changes as they are made by a user to the dynamic parallel text. The machine translation service may further track the geographic location of the user so as to identify regional differences in language and thus improve the translation model or algorithm.

In some embodiments, the machine translation service is self-improving, i.e., it is capable of improving its translation model or algorithm by self-analysis. For example, the machine translation service may track changes made to parallel news content and run statistical analysis on the changes to refine its translation model or algorithm.

In some embodiments, the machine translation service is provided using software and parallel text database(s) residing on a server in the social network platform. In some embodiments, the machine translation service is provided by a third-party outside the social network platform.

In some embodiments, a source of translation (e.g., machine translation, professional translation, user-generated, author-generated, etc.) may be indicated. For example, a sub-heading of a new article may indicate it was translated via a professional service while a linked comment may indicate it was translated by machine.

In some embodiments, the machine translation service is configured to provide an estimate of the accuracy of a machine translation. In some embodiments an accuracy “heat map” is provided wherein different word pairs, phrase pairs, sentence pairs, or the like are assigned a color according to an estimate of accuracy. For example, portions of the translation having a high estimate of accuracy may be indicated using warm colors while portions of the translation having a low estimate of accuracy may be indicated using cool colors. The heat map may be presented as a background upon which text is printed or may be presented as the color of the text itself. In some embodiments, an overall accuracy score is provided for the machine translation. In some embodiments, the estimate of accuracy may refer to the probability that a given word pair, phrase pair, sentence pair, or other suitable portion of the content has been translated correctly.

Methods for providing a social network service are disclosed herewith. In some embodiments, the method comprises providing news content to a user. The method may comprise providing search functionality to a user. The method may comprise providing parallel news content in another language to a user. The method may comprise registering a user. The method may comprise providing a heat map of social network activity or sentiment. The method may comprise associating a metadata tag set with a user. The method may comprise receiving user-generated content from a user. The method may comprise subscribing a user to another user. The method may comprise defining trending content for a user according to the user's preferences.

The above described social network system and social network platform may be implemented as a combination of computer hardware, software, and/or firmware The methods, services, and functions described above may be implemented as computer software and/or firmware. The social network clients as described above may be implemented as software, firmware, and/or hardware.

The methods, services, functions, and clients described above may be embodied on computer readable storage media The computer readable storage media may comprise instruction which, when executed by a processor, cause a computer to perform the methods and functionality described above. The computer readable storage media may comprise instruction which, when executed by a processor, cause a computer to provide the services described above. The computer readable storage media may comprise any known form of computer storage including, but not limited to, magnetic storage media (e.g., hard drives, disk drives, magnetic tape, etc.), optical storage media (e.g., compact disc, laser disc, digital video disc, Blu-ray disc, magneto-optical storage, holographic data storage, 3D optical data storage, etc.), mechanical storage medium (e.g., punch card, Capacitance Electronic Disc, etc.), Read Only Memory (ROM), mask ROM, programmable ROM (PROM), erasable PROM (EPROM), electronically erasable PROM (EEPROM), flash memory, solid state memory, random access memory (RAM), dynamic RAM (DRAM), static RAM (SRAM), or non-volatile RAM (NVRAM).

It will be obvious to those having skill in the art that many changes may be made to the details of the above-described embodiments without departing from the underlying principles of the invention. Moreover, any reference to claim elements in the singular, such as in the articles “a,” “an,” or “the,” should not limit the element to the singular. The scope of the present invention should, therefore, be determined only by the following claims and their equivalents.

1. A method for displaying content comprising:
receiving a first content at a server, wherein said first content is ranked by at least one user;
receiving a second content at a server;
linking the second content to the first content;
receiving a request for content;
filtering the request for content using at least one geographic location as a filtering parameter;
displaying the results of the request for content on a geographic map, wherein the prominence of each content displayed is determined according to at least the content's ranking.

2. The method of claim 1, wherein at least one of said first or second content comprises at least one of the following: a news article, a report, a document, a video file, an audio file, an image, a poll, a comment, a discussion, a request for information, a legal opinion.

3. The method of claim 1, wherein at least one of said first or second content further comprises metadata describing at least one of the following: authorship; a date of publication; popularity of said first or second content, respectively; a number of links to said first or second content, respectively; a geographic location or region from which said first or second content originated, respectively; a geographic location or region where said first or second content is active, respectively.

4. The method of claim 1, wherein a user assigns to a third content a geotag using a symbol, wherein said symbol prepends the name of a geographic location used to geotag said third content.

5. The method of claim 1, wherein said request for content is further filtered using at least one of the following parameters: a geographic location, a username, a hash tag, authorship, popularity of the content, a number of comments associated with said content, a date of publication.

6. The method of claim 1, wherein at least one of said first or second content was received from at least one of the following: a syndicated news source, a social media service, an internet forum, an automated news feed, a podcast, a personal user, a registered user, an unregistered user.

7. The method of claim 1, wherein a user may toggle between two or more aliases within the same account and may subscribe to the actions of other users.

8. A non-transitory, computer-readable medium that stores instructions, which, when executed by a computer processor, cause said processor to:
receive a first content at a server, wherein said first content is ranked by at least one user;
receive a second content at a server;
link the second content to the first content;
receive a request for content;
filter the request for content using at least one geographic location as a filtering parameter;
display the results of the request for content on a geographic map, wherein the prominence of each content displayed is determined according to at least the content's ranking.

9. The method of claim 8, wherein at least one of said first or second content comprises at least one of the following: a news article, a report, a document, a video file, an audio file, an image, a poll, a comment, a discussion, a request for information, a legal opinion.

10. The method of claim 8, wherein at least one of said first or second content further comprises metadata describing at least one of the following: authorship; a date of publication;
popularity of said first or second content, respectively; a number of links to said first or second content, respectively; a geographic location or region from which said first or second content originated, respectively; a geographic location or region where said first or second content is active, respectively.

11. The method of claim 8, wherein a user assigns to a third content a geotag using a symbol, wherein said symbol prepends the name of a geographic location used to geotag said third content.

12. The method of claim 8, wherein said request for content is further filtered using at least one of the following parameters: a geographic location, a username, a hash tag, authorship, popularity of the content, a number of comments associated with said content, a date of publication.

13. The method of claim 8, wherein at least one of said first or second content was received from at least one of the following: a syndicated news source, a social media service, an internet forum, an automated news feed, a podcast, a personal user, a registered user, an unregistered user.

14. The method of claim 8, wherein a user may toggle between two or more aliases within the same account and may subscribe to the actions of other users.

15. A system comprising:
a computer processor; and
a routing engine executing on the processor and configured to:
receive a first content at a server, wherein said first content is ranked by at least one user;
receive a second content at a server;
link the second content to the first content;
receive a request for content;
filter the request for content using at least one geographic location as a filtering parameter;
display the results of the request for content on a geographic map, wherein the prominence of each content displayed is determined according to at least the content's ranking.

16. The method of claim 15, wherein at least one of said first or second content comprises at least one of the following: a news article, a report, a document, a video file, an audio file, an image, a poll, a comment, a discussion, a request for information, a legal opinion.

17. The method of claim 15, wherein at least one of said first or second content further comprises metadata describing at least one of the following: authorship; a date of publication;
popularity of said first or second content, respectively; a number of links to said first or second content, respectively; a geographic location or region from which said first or second content originated, respectively; a geographic location or region where said first or second content is active, respectively.

18. The method of claim 15, wherein a user assigns to a third content a geotag using a symbol, wherein said symbol prepends the name of a geographic location used to geotag said third content.

19. The method of claim 15, wherein said request for content is further filtered using at least one of the following parameters: a geographic location, a username, a hash tag, authorship, popularity of the content, a number of comments associated with said content, a date of publication.

20. The method of claim 15, wherein a user may toggle between two or more aliases within the same account and may subscribe to the actions of other users.
